(19) United States
(12) Patent Application Publication
(10) Pub. No.: US 2025/0029007 A1
(43) Pub. Date: Jan. 23, 2025

(54) ELIMINATION CAPABILITY FOR ACTIVE MACHINE LEARNING

(71) Applicant: Duke University, Durham, NC (US)

(72) Inventors: Daniel Reker, Durham, NC (US); Yan Xiang, Durham, NC (US); Samuel James Kang-Li Wang, Durham, NC (US)

(21) Appl. No.: 18/775,795

(22) Filed: Jul. 17, 2024

Related U.S. Application Data
(60) Provisional application No. 63/527,205, filed on Jul. 17, 2023.

(51) Int. Cl. G06N 20/00

(52) U.S. Cl. CPC G06N 20/00

(57) ABSTRACT

A method of datapoint elimination for an active learning algorithm includes monitoring datapoints in a labeled training dataset as new labeled datapoints are added to the labeled training dataset; determining whether datapoints in the labeled training dataset satisfy a criterion for elimination operations of an elimination protocol; and applying the elimination operations of the elimination protocol to remove one or more datapoints from the labeled training dataset.

### BACKGROUND

Active learning is a subfield of machine learning and artificial intelligence. Active machine learning enables the automated selection of the next experiments for training a machine learning model to improve predictive modeling. In active machine learning, the machine learning algorithm can request additional data and thereby adaptively improve predictive performance while minimizing labeling efforts. Indeed, learning algorithms can interactively query an oracle (e.g., a human or other information source) to label new datapoints. The selection of data for labeling can be based on algorithmic notions of informativeness, which commonly include measures of predictive uncertainty and potential impact of a datapoint on the machine learning model architecture.

### BRIEF SUMMARY

An elimination capability for active machine learning is described. Systems and methods for active learning having the described elimination capability can lead to improved or equal predictive performance for active machine learning while reducing computational cost. In addition, the described elimination capability can lead to the capability to eliminate erroneous data from the training data.

In some aspects, the techniques described herein relate to a method of datapoint elimination for an active learning algorithm, including: monitoring datapoints in a labeled training dataset as new labeled datapoints are added to the labeled training dataset; determining that the datapoints in the labeled training dataset satisfy a criterion for elimination operations of an elimination protocol; and applying the elimination operations of the elimination protocol to remove one or more datapoints from the labeled training dataset. An active learning model can be updated based on the labeled training dataset after the one or more datapoints from the labeled training dataset.

A computing system performing an active learning method can include a processing system, a storage system, and instructions for an active learning method having elimination capabilities stored on the storage system that when executed by the processing system direct the computing system to: select one or more datapoints from one or more resources; query an oracle for a label for each of the one or more datapoints that are unlabeled; add labeled datapoints to a labeled training dataset; train an active learning model using the labeled training dataset; monitor datapoints in the labeled training dataset as new labeled datapoints are added to the labeled training dataset; determine whether datapoints in the labeled training dataset satisfy a criterion for elimination operations of an elimination protocol; apply the elimination operations of the elimination protocol to remove one or more datapoints from the labeled training dataset; and update the machine learning model using an updated labeled training dataset as resulting from applying the elimination operations of the elimination protocol. Active learning iterations can continue by restarting the active learning method as described until a stopping criterion is reached or the process is halted manually or through another external process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example active learning process.

FIG. 2 illustrates an example active learning process incorporating an elimination capability as described herein.

FIG. 3 illustrates a method of datapoint elimination for an active learning algorithm.

FIGS. 4A-4C illustrate an example scenario of an active learning method with elimination capability.

FIGS. 5A and 5B illustrate two example elimination protocols. FIG. 5A illustrates an example Forget First elimination protocol and FIG. 5B illustrates an example Out-of-Bag Uncertainty elimination protocol.

FIG. 6 shows the active learning curves for the different datasets on which an active learning algorithm of a random forest classifier with different elimination protocols was applied.

FIGS. 7A-7C illustrate data selection cost across datasets for different elimination protocols.

FIGS. 8A-8C show effects of dataset perturbation.

FIG. 9 illustrates components of a computing system that may be used in certain embodiments described herein.

### DETAILED DESCRIPTION

An elimination capability for active machine learning is described. Systems and methods for active learning having the described elimination capability can lead to improved or equal predictive performance for active machine learning while reducing computational cost. In addition, the described elimination capability can lead to the capability to eliminate erroneous data from the training data. The described elimination capability performs datapoint elimination, which can facilitate reduction or maintenance of a footprint (e.g., storage requirements) as well as a higher interpretability of a model and reduced training and prediction time and cost. In addition, through the various approaches available by the described elimination capability, the training data can be targeted to ‘most useful’ for the model at a particular time.

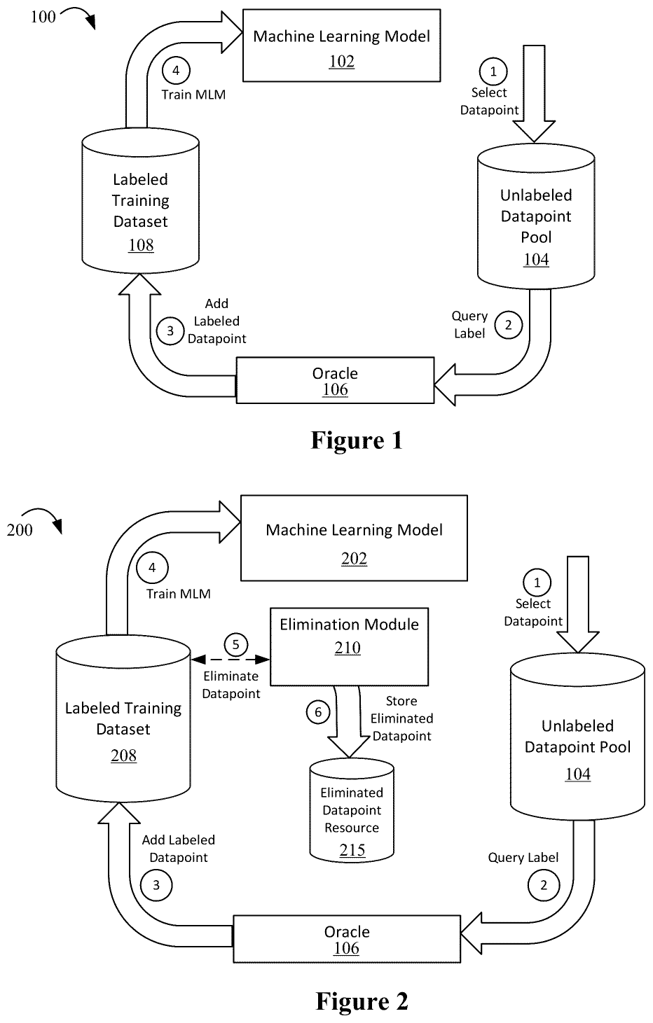

FIG. 1 illustrates an example active learning process. Active machine learning (referred to herein interchangeably with “active learning”) is a type of machine learning in which a machine learning algorithm can interactively query an oracle (e.g., human user or some other information source including programmatic) to label new datapoints for training data with the desired outputs. In active learning, the algorithm can actively choose, from a pool of unlabeled data, a subset of datapoints to be labelled next.

As illustrated in FIG. 1, while building up a training dataset, an active learning process 100 includes selecting (e.g., by the machine learning algorithm) a datapoint for a particular machine learning model 102 from an unlabeled datapoint pool 104, as shown in step (1). The unlabeled datapoint pool 104 can include an abundance of unlabeled datapoints (e.g., using a pool-based active learning setting). In some cases, the selection of the datapoint may use an uncertainty sampling query strategy where the instance in the pool is selected because the model is least certain how to label this instance. For example, when using a probabilistic model for binary classification, uncertainty sampling selects the instance whose posterior probability of being positive is nearest 50%. As another example, when using a non-probabilistic classifier, an ensemble of decision tree classifiers may be used and the instance with the largest disagreement among the ensemble is selected. In some cases, a stream-based or sequential approach is taken where each unlabeled instance is drawn from a data source and evaluated by some measure, such as some “informativeness measure” or “query strategy” to determine whether it should be selected. In some cases, a decision-theoretic approach to selection is used where an instance that would impart the greatest change to the current model if the label was known is selected (e.g., an expected gradient length approach) or an instance that would reduce the generalization error the most (e.g., an expected error reduction approach or an output variance minimization approach). Of course, there are any number of suitable selection strategies that may be used that are now known or developed in the future.

Once the datapoint has been selected, process 100 can include querying (e.g., by the machine learning algorithm) an oracle 106 to label the selected datapoint, as shown in step (2). The oracle 106 can be a human user or some other information source. For example, in the context of molecule behavior-related identification or classification, the oracle 106 can include an experiment conducted to capture the information of the behavior (e.g., toxicity, chemical interaction, bioavailability, etc.)

In step (3) of process 100, the labeled datapoint is added to a labeled training set 108. The updated labeled training dataset 108 can be used to train the machine learning model 102, as shown in step (4). In some cases, the machine learning model 102 is re-trained each time one or more new labeled datapoints are added to the labeled training dataset 108. The completion of steps (1)-(5) of process 100 can be referred to as an “iteration.” With each subsequent iteration of active learning process 100, the machine learning model 102 is trained on the labeled training dataset 108 as more labeled datapoints are added.

Conventional active learning methods focus on the addition of new datapoints to the labeled training dataset 108. Typically, as soon as a datapoint has been selected for labeling, it cannot be removed from the labeled training dataset 108. This can be problematic given that active learning selection functions are likely to be imperfect, especially during early active learning iterations where limited data can produce inaccurate machine learning models that will be poor at selecting informative datapoints.

In many cases, the datasets used to train machine learning models have size constraints and may only store a limited amount of datapoints. When there is no management (e.g., elimination) of datapoints in the dataset used to train machine learning models, as datapoints are added, at some point, the performance of the model reaches a maximum performance level, and the model performance may decrease as additional datapoints are added. As such, consistently adding more datapoints (without removing any datapoints) can increase error and yield significant performance losses.

Advantageously, an elimination capability as described herein can be used during an active learning method to select and eliminate data from the labeled training dataset 108 to maintain optimal dataset sizes and promote selection and retention of the most useful datapoints. The described elimination capability is suitable for any active learning algorithm. As one example, the described elimination capability is applicable for an active learning algorithm that performs drug-target interaction prediction. The labeled training datapoints for the drug-target interaction prediction can include molecules and associated activities. Other example implementations include drug toxicity and bioavailability prediction.

FIG. 2 illustrates an example active learning process incorporating an elimination capability. Referring to FIG. 2, similar to that described with respect to FIG. 1, at step (1), a datapoint is selected from the unlabeled datapoint pool 104. At step (2), a query is sent to an oracle 106, where the query includes a request for a label for the datapoint. At step (3), the labeled datapoint is added to the labeled training dataset 208; and at step (4), the machine learning model 202 is trained on the labeled training dataset 208. However, by the inclusion of the described elimination capability (shown in FIG. 2 as elimination module 210), datapoints of the labeled training dataset 208 can be removed and the machine learning model 202 can be trained on a labeled training dataset 208 that has had datapoints removed.

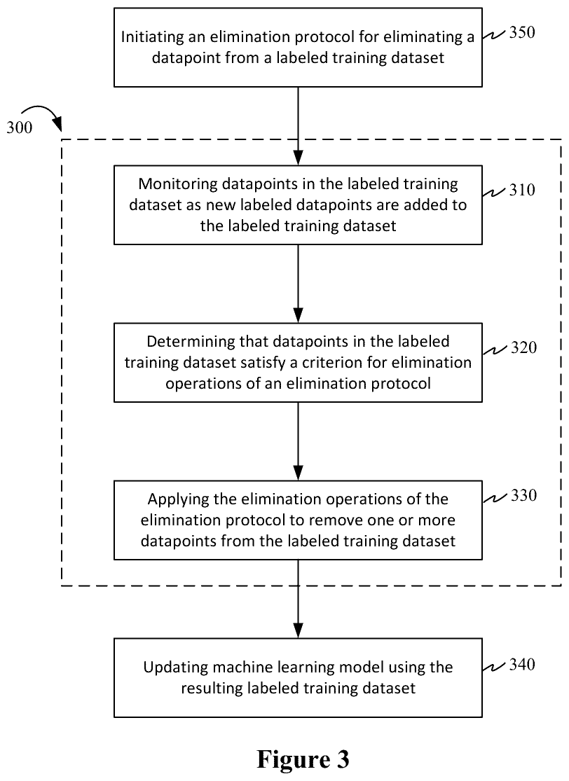

In detail, at step (5), the elimination module 210 can select a labeled datapoint from the labeled training dataset 208 to eliminate that labeled datapoint from the labeled training dataset 208. Elimination module 210 can contain the instructions to perform method 300 described with respect to FIG. 3.

In some cases, as shown in step (6), the elimination module 210 can add the eliminated labeled datapoint (and information associated with the eliminated datapoint) to an eliminated datapoint resource 215. In some cases, the elimination module 210 can add the eliminated labeled datapoint to a reference list that records the datapoints that have been eliminated.

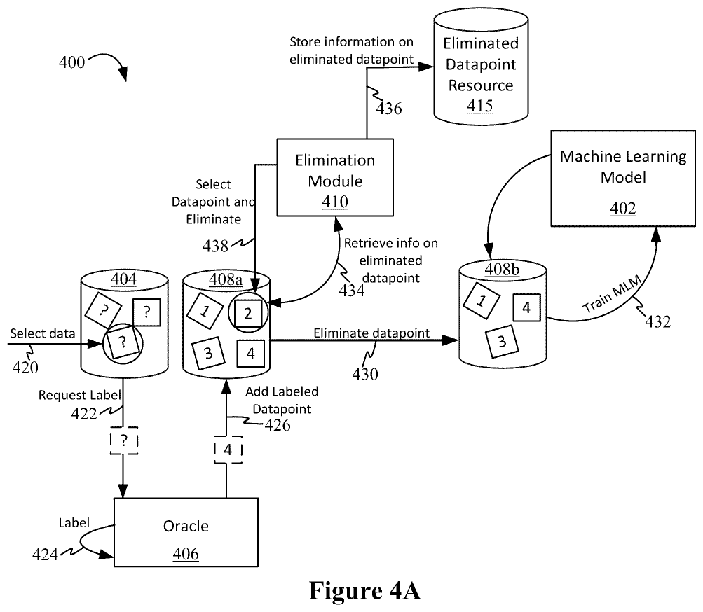

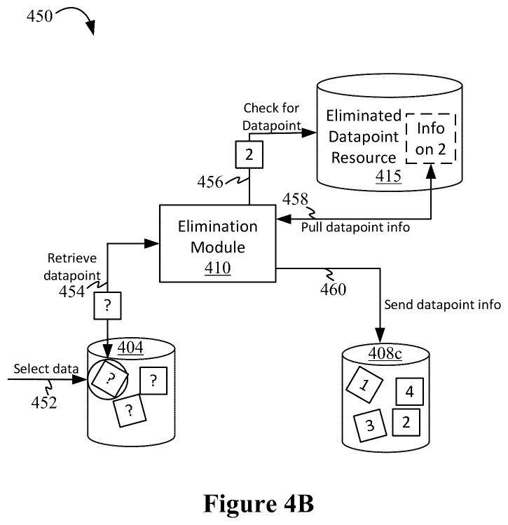

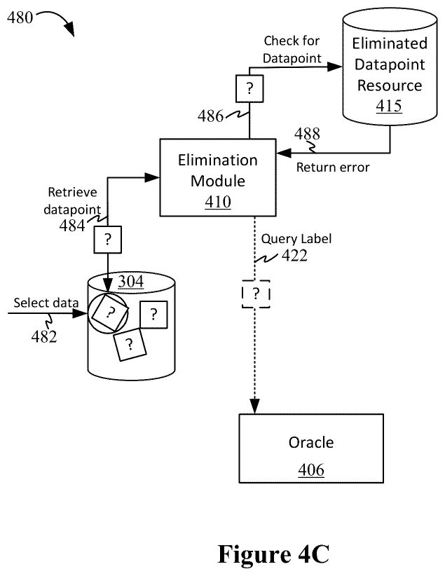

It is possible that a particular datapoint eliminated from the labeled training dataset 208 is one that is actually a useful datapoint for training the model 202. Advantageously, as also described in more detail with respect to FIG. 4B, eliminated datapoints can be reintegrated from the eliminated datapoint resource 215 to the labeled training dataset 208 and used to update the machine learning model 202. For example, in one implementation, the eliminated datapoint resource 215 can also be included in the select datapoint function (e.g., step 1 operation), where the selection is carried out on unlabeled datapoint pool 104 and on the eliminated datapoint resource 215 such that the select datapoint function (e.g., step 1 operation) can select a datapoint from resource 215 for re-integration into the labeled training dataset 208. When a datapoint is selected from the unlabeled datapoint pool 104, a query is made to the oracle 106. However, when a datapoint is selected from resource 215, the datapoint can be directly integrated into training dataset 208 without querying the oracle 106 again.

FIG. 3 illustrates a method of datapoint elimination for an active learning algorithm. Referring to FIG. 3, method 300 includes monitoring (310) datapoints in a labeled training dataset as new labeled datapoints are added to the labeled training dataset; determining (320) that the datapoints in the labeled training dataset satisfy a criterion for elimination operations of an elimination protocol; and applying (330) the elimination operations of the elimination protocol to remove one or more datapoints from the labeled training dataset.

The active learning algorithm can then update (340) a machine learning model using the labeled training dataset resulting from iterations of method 300. Updating (340) the machine learning model can be performed each time the elimination operations are applied, at some predetermined interval, or as some other triggered operation.

In some cases, method 300 can further include initiating (350) an elimination protocol for eliminating a datapoint from a labeled training dataset. The initiating (350) of the elimination protocol may include processes occurring before beginning monitoring (310) of datapoints or and/or after determining (320) that the datapoints satisfy a criterion for elimination operations. Initiating (350) an elimination protocol for eliminating a datapoint from a labeled training dataset can include a variety of processes. For example, access to a storage resource for a labeled training dataset can be set up so that an elimination module 210 can read and optionally write to the storage resource. There may be other integrations with an active learning algorithm (and/or associated systems) that can be set up as part of initiating the elimination protocol. In addition, some elimination protocols require seeding of certain values and other pre-processes before operations begin.

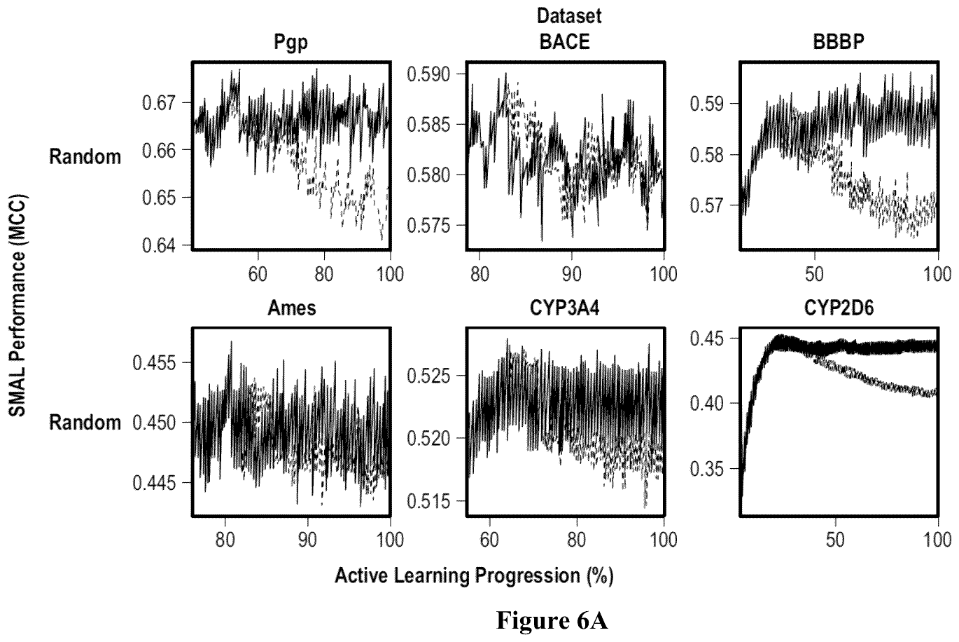

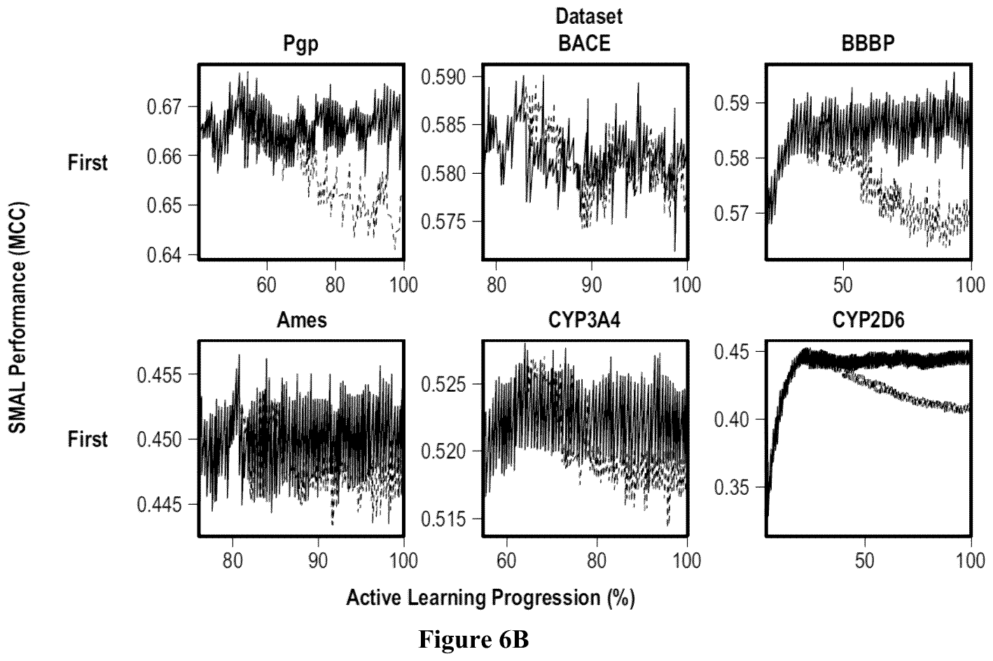

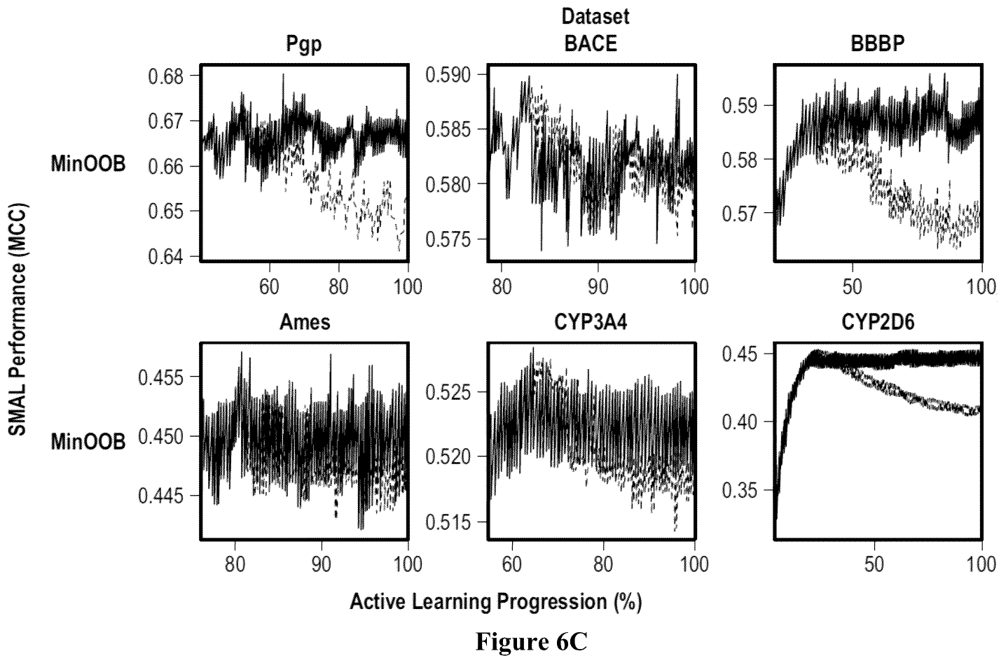

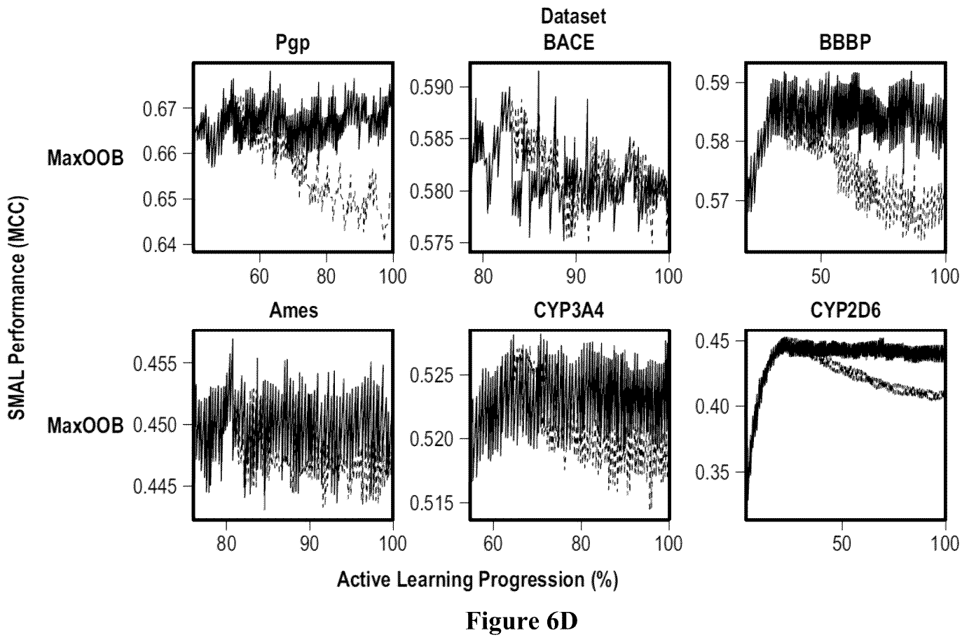

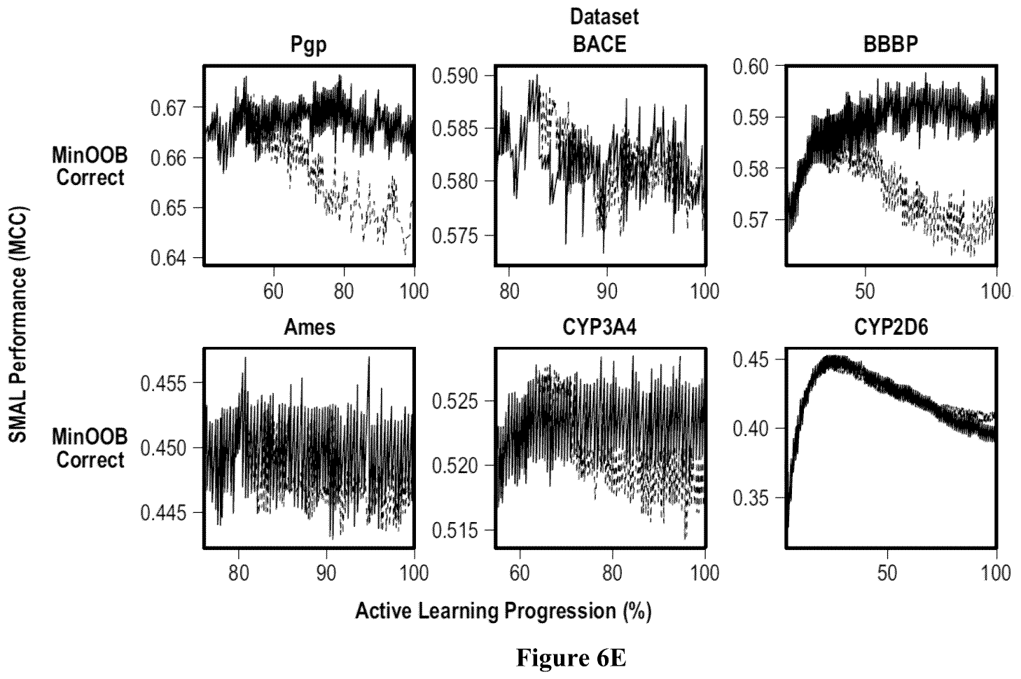

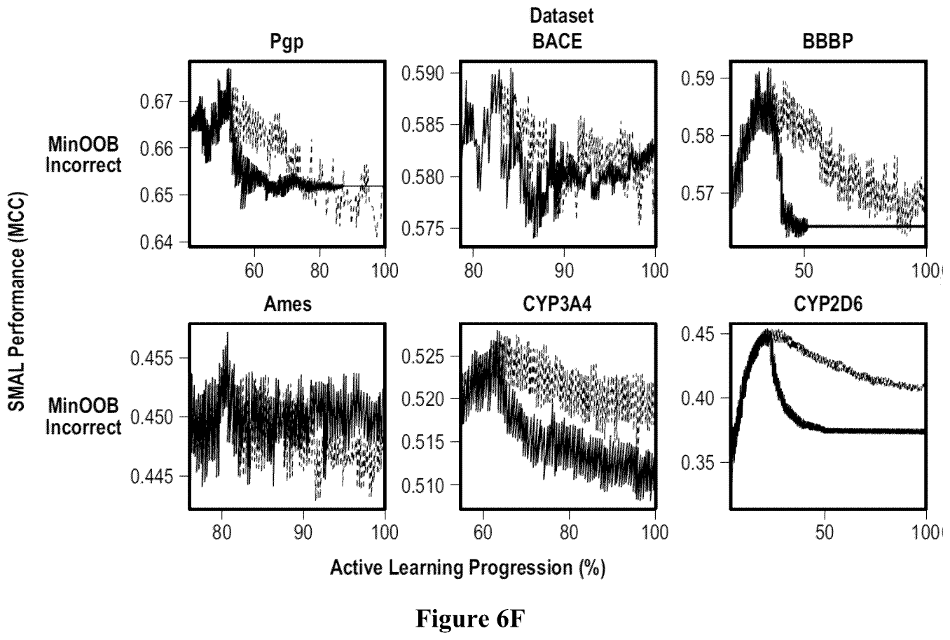

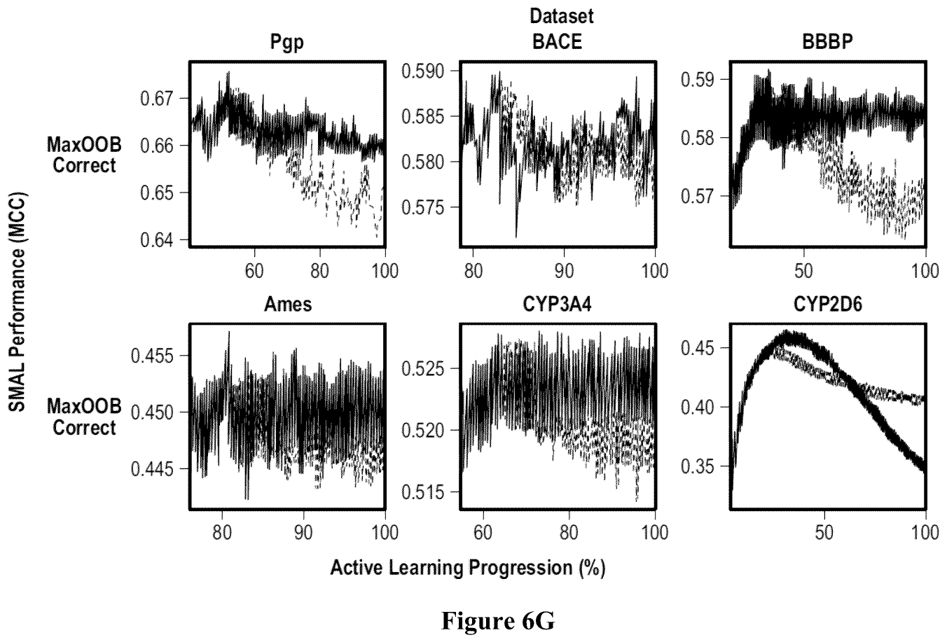

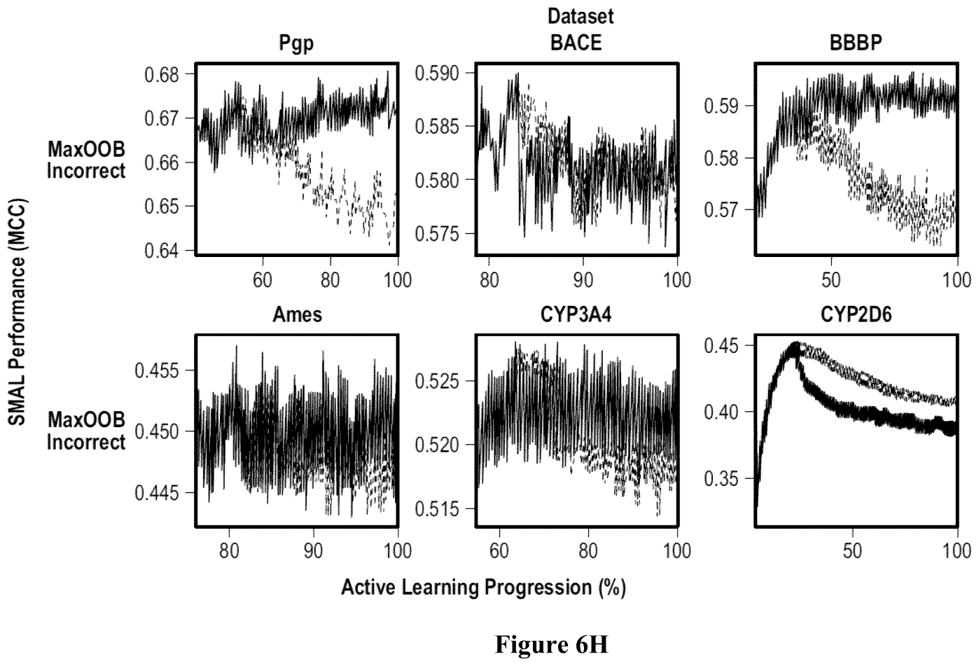

In some cases, initiating (350) an elimination protocol for eliminating a datapoint from a labeled training dataset includes identifying the elimination protocol from a set of available elimination protocols based on a type of dataset on which the active learning algorithm acts. As can be seen from Examples described with respect to FIGS. 6, 7A-7C, and 8A-8C, different datasets respond differently to different elimination protocols, and it is possible to identify an optimal elimination protocol. In addition to, or as an alternative to identifying an optimal elimination protocol based on the type of dataset, other mechanisms to identify an optimal elimination protocol can be used. For example, the elimination protocol can be identified from a set of available elimination protocols based on prior experience of applicable selection functions. As another example, the elimination protocol can be identified from a set of available elimination protocols based on the specific machine learning model being used. As yet another example, the elimination protocol can be identified by an automated selection/switching process. Of course, a combination of one or more of the above-described mechanisms may be used.

The elimination protocol can be identified programmatically or indicated via a user input. The selection of an optimal elimination protocol can be based on comparing the performance of different elimination protocols and to a default active learning process (without elimination) to identify an optimal elimination strategy for a particular dataset and/or active learning algorithm. In some cases, as part of evaluating a performance of an elimination protocol, erroneous/corrupted data can be intentionally introduced to a training data pool and the ability of a particular elimination protocol to remove the erroneous data can be tracked.

Example elimination protocols include, but are not limited to, Forget Random, Forget First, uncertainty-based elimination protocols such as Forget Minimum Out-of-Bag Uncertainty (OOBU), Forget Maximum OOBU, Forget Minimum OOBU Incorrect, Forget Minimum OOBU Correct, Forget Maximum OOBU Incorrect, and Forget Maximum OOBU Correct, and other uncertainty-based elimination protocols. In some cases, the particular elimination protocol can begin as one elimination protocol and can be updated to a different elimination protocol based on user input or automatic updates (which may be triggered by a monitoring system, the active learning algorithm, or programmatically).

Determining (320) that the datapoints in the labeled training dataset satisfy a criterion for elimination operations can include determining when to start applying the elimination operations of the elimination protocol and when to trigger a next elimination operation by the elimination protocol. For example, the criterion for elimination operations can be based at least in part on a number of datapoints in the training dataset and monitoring (310) the datapoints in the labeled training dataset as new labeled datapoints are added to the labeled training dataset includes tracking an amount of datapoints as the new labeled datapoints are added. Determining (320) whether or not datapoints in the labeled dataset satisfy a criterion for elimination operations provides a capability to decide to not eliminate (e.g., due to a certain training dataset size not yet being reached or because no datapoint in the training data is characterized by the elimination module 210 as suitable for elimination).

In some cases, the elimination module 210 can start eliminating datapoints from the labeled training dataset 208 after n datapoints (where n is greater than 1) are added to the labeled training dataset 208. In some cases, n is established based on a dataset size corresponding to decreased performance of the machine learning model (e.g., as determined in a separate testing scenario evaluating the performance of the machine learning model as the number of datapoints are increased). In such cases, the elimination module 210 does not apply an elimination protocol until the labeled training dataset 208 contains n datapoints.

In some cases, the elimination module 210 eliminates one datapoint from the labeled training dataset 208 for each one datapoint added to the labeled training dataset 208. In some cases, the elimination module 210 eliminates multiple datapoints each time datapoints are removed. For example, after a certain number of datapoints are added to the labeled training dataset 208, an equal number can be removed in a group. In some cases, more or fewer datapoints are eliminated than added to the labeled training dataset 208 at any given time. The rate of removal and number of datapoints eliminated can be part of the criteria for elimination operations. Other criteria for elimination operations can include error rates (e.g., number of errors found in the labeled training data) as well as other measures of usefulness.

Applying (330) the elimination operations of the elimination protocol involves performing the process to select the datapoint to remove.

Following the Forget Random forgetting protocol, the elimination module 210 randomly selects a training datapoint from the labeled training dataset 208 to eliminate.

Following the Forget First forgetting protocol, the elimination module 210 selects the training datapoint that has been in the labeled training dataset 208 the longest to eliminate (e.g., the oldest training datapoint).

Out-of-bag uncertainty (OOBU) allows for the quantification of how confident a model is about datapoints that it already includes in the training (e.g., datapoints in the labeled training dataset 208) and can be used in conjunction with quantification of how accurate the model is at predicting those datapoints that are in the labeled training dataset 208. In some instances of this process, the model is re-trained on all datapoints except the ones to be evaluated to assess the predictive performance. In other instances, specific models such as random forest ensembles can be used where some of the trees have not been trained with this datapoint and can therefore be used to evaluate the performance of the model on these datapoints (i.e., out-of-bag performance).

Following the Forget Maximum OOBU forgetting protocol, the elimination module 210 uses a model's quantification of predictive out-of-bag uncertainty and selects the training datapoint in the labeled training dataset 208 with the most uncertain prediction to eliminate.

Following the Forget Minimum OOBU forgetting protocol, the elimination module 210 uses a model's quantification of predictive out-of-bag uncertainty and selects the training datapoint in the labeled training dataset 208 with the least uncertain prediction to eliminate.

Following the Forget Maximum OOBU Incorrect forgetting protocol, the elimination module 210 selects the most uncertain predicted training datapoint from the labeled training dataset 208 to eliminate while considering if the datapoint's class label was also predicted incorrectly out-of-bag.

Following the Forget Maximum OOBU Correct forgetting protocol, the elimination module 210 selects the most uncertain predicted training datapoint from the labeled training dataset 208 to eliminate while considering if the datapoint's class label was also predicted correctly out-of-bag.

Following the Forget Minimum OOBU Incorrect forgetting protocol, the elimination module 210 selects the least uncertain predicted training datapoint from the labeled training dataset 208 to eliminate while considering if the datapoint's class label was also predicted incorrectly out-of-bag.

Following the Forget Minimum OOBU Correct forgetting protocol, the elimination module 210 selects the least uncertain predicted training datapoint from the labeled training dataset 208 to eliminate while considering if the datapoint's class label was also predicted correctly out-of-bag.

Advantageously, through performing method 300, the elimination module 210 ensures that, during the active learning method 200, the labeled training dataset 208 is maintained to promote retention of data that is most useful, and elimination of datapoints that are less useful or even harmful. For example, datapoints added to the labeled training dataset 208 towards the beginning of the training of the machine learning model 202, when the machine learning model 202 was less sophisticated, may not be as beneficial to the training of the machine learning model 202 at a later point. The elimination module 210 promotes retaining an optimal dataset size of the labeled training dataset 208 while ensuring that the data retained in the labeled training dataset 208 is sufficiently useful. By reducing and/or maintaining the number of datapoints in the labeled training dataset 208, the machine learning model 202 can be more compact and have less bias.

FIGS. 4A-4C illustrate example scenarios of an active learning method with elimination capability. Referring to FIG. 4A, scenario 400 can begin by an active learning method selecting (420) an unlabeled datapoint from the unlabeled datapoint pool 404. Once the unlabeled datapoint is selected (420), a label for the datapoint is requested (422) from an oracle 406. The oracle 406 can label (424) the datapoint. The labeled training dataset 308a can receive the labeled datapoint.

Upon the labeled datapoint being received (426) at the labeled training dataset 308a, the elimination module 410 can select (428) a datapoint from the labeled training dataset 308a to eliminate. In this example, the elimination module 410 selects datapoint “2” to be eliminated. The selected datapoint “2” can be eliminated (430) from the labeled training dataset 308a, thereby creating the updated state of the labeled training dataset 308b. The machine learning model 402 can thus be trained (432) on the labeled training dataset 308b.

When indicating to remove the datapoint from the labeled training dataset, the elimination module 410 can obtain (434) information related to the eliminated datapoint (e.g., datapoint “2”) and can store (436) the information related to the eliminated datapoint at an eliminated datapoint resource 415. The information related to the eliminated datapoint can include data of an iteration through the active learning model along with the label(s) of the datapoint. In some cases, other information can be included for assisting with evaluating the active learning model/elimination capability. For example, in some cases, the information related to the eliminated datapoint may include whether the datapoint was intentionally corrupted (e.g., to track whether the active learning model can autonomously remove corrupted data).

Referring to FIGS. 4A and 4B, the next scenario 450 can begin by the active learning method selecting (452) an unlabeled datapoint from the unlabeled datapoint pool 404. In some cases, the selected unlabeled datapoint corresponds to a datapoint that was previously eliminated from the labeled training dataset and stored (436) in an eliminated datapoint resource 415. In such cases, the elimination module 410 can retrieve (454) the datapoint and check (456) the eliminated datapoint resource 415 for information for a removed datapoint corresponding to the datapoint. In some cases, the elimination module 410 can check a reference list of eliminated datapoints to determine if the unlabeled datapoint corresponds to a previously eliminated datapoint so that this datapoint can be reintegrated in the training data.

In the illustrated scenario, eliminated datapoint resource 415 is storing information on datapoint “2” (e.g., in response to datapoint “2” being eliminated (428) by the elimination module 410 and the information on the eliminated datapoint being stored (432) in scenario 400 of FIG. 4A).

As a result, the elimination module 410 can pull (458) the information on datapoint “2” and send (460) the information on datapoint “2” for the labeled training dataset 408c.

Because the elimination module 410 can simply reintegrate the datapoint information associated with the previously eliminated datapoint “2” (e.g., as opposed to requesting novel labels at every iteration), there are fewer label queries needed. Additionally, due to re-integration of datapoints, novel training set combinations can be uncovered, improving datapoint diversity and reducing corruption when data is perturbed.

Advantageously, by storing the eliminated labeled datapoint, there is no need to query the oracle again (e.g., run an experiment to determine the label of datapoint). Conventionally, in active learning, for every iteration, another round of querying the oracle is performed. By storing the eliminated datapoint (e.g., datapoint “2”), which has already been used previously as part of a labeled training dataset the elimination module 410 can simply reintegrate an eliminated datapoint into labeled training data 108 instead of querying the oracle 106 again.

Referring to FIGS. 4A and 4C, the scenario 480 can begin with the active learning method selecting (482) an unlabeled datapoint from the unlabeled datapoint pool 404. In some cases, the elimination module 410 can retrieve (484) the datapoint and check (486) the eliminated datapoint resource 415 for information for a removed datapoint corresponding to the datapoint. In this scenario, eliminated datapoint resource 415 is not storing information on the selected datapoint and is unable to retrieve any information. The eliminated datapoint resource 415 returns (488) an error to the elimination module 410. In response, the elimination module 410 can query (422) an oracle to label the datapoint and continue scenario 400 as described with respect to FIG. 4A.

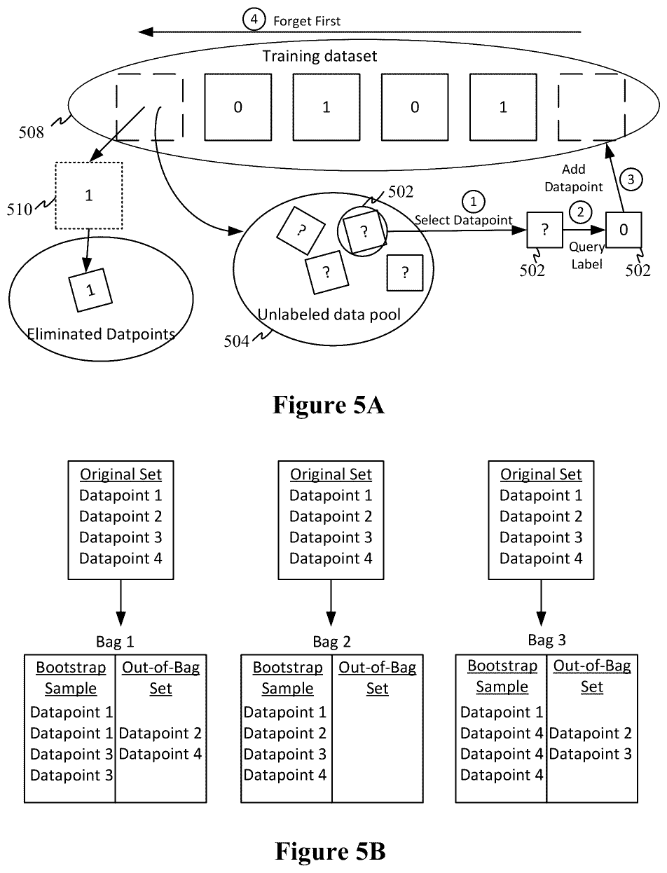

FIGS. 5A and 5B illustrate two example elimination protocols.

FIG. 5A illustrates an example active learning method using Forget First elimination protocol. Referring to FIG. 5A, an example active learning method using Forget First elimination protocol can include selecting, by the active learning model at step (1), a datapoint 502 from the unlabeled datapoint pool 504 (e.g., unlabeled datapoint pool 204 described with respect to FIG. 2); and labeling the datapoint 502 at step (2). Once the datapoint 502 is labeled, the datapoint 502 is added by the active learning method to the labeled training dataset 508. Then, in accordance with the Forget First elimination protocol, the oldest datapoint 510 in the labeled training dataset 508 is selected (4) to be eliminated, which can be accomplished by shifting an index as the new datapoint is added. The eliminated datapoint 510 can be stored in an eliminated datapoint resource 215 as described with respect to FIG. 2.

FIG. 5B illustrates an example Out-of-Bag Uncertainty elimination protocol. Referring to FIG. 5B, the Out-of-Bag Uncertainty elimination protocol can utilize out-of-bag (OOB) error (also referred to as an OOB estimate). OOB error is a method of measuring the prediction error of random forests, boosted decision trees, and other machine learning models utilizing bootstrap aggregation. While building a machine learning model, each tree is trained using a subset of the original data, known as the bootstrap sample. During the training process, some observations are left out or OOB for each tree. For example, for Bag 1, the bootstrap sample includes datapoint 1, datapoint 1, datapoint 3, and datapoint 3, and the OOB set includes datapoint 2 and datapoint 4.

As an illustrative example, OOB Uncertainty can be quantified as the disagreement amongst trees within the random forest. In such a case, there will be a tree trained on the bootstrap sample for each respective bag (e.g., for the illustrative scenario, the random forest has three trees). If tree 1 predicts OOB that Datapoint 2 should be class A, but tree 3 predicts Datapoint 2 should be class B, then there is a high uncertainty due to disagreement. On the other hand, if tree 1 and tree 3 both predict the same class for Datapoint 2, then there is a low uncertainty since they agree. Of course, in real applications, random forests have tens to thousands of trees. With tens to thousands of trees, the quantification uses the proportion of trees in the forest voting class A vs the proportion of trees voting class B for the trees with a particular datapoint out of bag. These values can be translated directly into an uncertainty metric. Examining the OOB predictions allows for an unbiased assessment of model uncertainty with respect to each datapoint in the training set since the trees used to calculate the values were not trained on those datapoints directly.

In some cases, the out-of-bag least uncertain datapoint is selected to be eliminated. In some cases, the out-of-bag most uncertain datapoint is selected to be eliminated.

### Example Implementations and Results

To show the impact of datapoint elimination on active learning algorithms, single-task binary classification datasets relevant to drug development were obtained from the Therapeutic Data Commons and MoleculeNet. “Pgp” (Broccatelli), with size 1,218 datapoints, contained small molecules annotated by whether they are transported by the transport protein P-glycoprotein, which significantly impacts the bioavailability of a molecule and the ability for cancer cells to develop resistance against this molecule. “BACE”, with size 1,513 datapoints, contained small molecules annotated for their ability to inhibit human β-secretase 1, which is considered essential for the generation of beta-amyloid peptides believed to be critical in the development of Alzheimer's disease. “BBBP”, with size 2,039 datapoints, contained small molecules annotated for their ability to cross the blood-brain barrier. “Ames”, with size 7,278 datapoints, contained small molecules annotated to cause mutagenicity according to the Ames test. “CYP3A4” (Veith), with 12,328 datapoints, contained small molecules annotated for their ability to inhibit CYP3A4, a member of the CYP P450 gene family (known for their involvement in the formation and metabolism of various chemicals within cells) found in the liver and intestine, and known to oxidize small foreign organic molecules. “CYP2D6” (Veith), with 13,130 datapoints, contained small molecules annotated for their ability to inhibit CYP2D6, a member of the CYP P450 gene family highly expressed in the liver and areas of the central nervous system.

Scikit-learn's random forest (RF) classifier was implemented using the default parameters. Upon initialization, the dataset was subject to a 50:50 scaffold train-test split. Established active learning protocols were then followed. The initial training set was constructed by randomly selecting a positive and negative datapoint from the pool set (all datapoints not currently included in the train or test set). With each subsequent iteration of active learning, the RF classifier was trained on the training set and then applied to predict the class of each datapoint in the pool set. The prediction uncertainty for each datapoint in the pool set was then quantified as the disagreement among trees, and through an explorative learning process the datapoint from the pool with the highest uncertainty was selected and added to the training set (simultaneously removing it from the pool). This process continued until termination when the training set consisted of all datapoints from the original training pool, i.e., the pool set was empty. Active learning was evaluated using Matthew's Correlation Coefficient (MCC). The active learning process was also repeated for 20 seeds of the initial training set, which determined the resulting active learning selection trajectory.

FIG. 6 shows the active learning curves for the different datasets on which an active learning algorithm of a random forest classifier with different elimination protocols was applied.

As can be seen from FIG. 6, BACE showed equal performance with the inclusion of an elimination protocol and Pgp and BBBP showed significant improvements when using any of the elimination protocols besides MinOOBU Incorrect. This maintaining or improving of performance is particularly noteworthy since incorporation of an elimination protocol reduces the amount of necessary training data to at least 83% and up to 23% of the original training dataset size, as reflected in the Table below.

Training set sizes (and percentages) associated with the iteration of maximum mean standard active learning performance. These training set sizes are an example of when to start eliminating datapoints with the elimination module during active learning.

| | | | | | | initial |
|---|---|---|---|---|---|---|
| | | | | | | unlabeled |
| | | | | | | datapoint |
| | 0% Error | 10% Error | 20% Error | 30% Error | 40% Error | pool 104 |
| Pgp | 320 (52.5%) | 337 (55.3%) | 378 (62.1%) | 302 (49.6%) | 504 (82.8%) | 609 |
| BACE | 628 (83.0%) | 462 (61.0%) | 556 (73.4%) | 551 (72.8%) | 650 (85.9%) | 757 |
| BBBP | 372 (36.5%) | 559 (54.8%) | 578 (56.7%) | 453 (44.4%) | 515 (50.5%) | 1020 |
| Ames | 2941 (80.8%) | 2968 (81.6%) | 2471 (67.9%) | 2247 (61.7%) | 1749 (48.1%) | 3639 |
| CYP3A4 | 3923 (63.6%) | 5346 (86.7%) | 5570 (90.4%) | 4375 (71.0%) | 4854 (78.7%) | 6164 |
| CYP2D6 | 1481 (22.6%) | 2176 (33.1%) | 2150 (32.7%) | 3394 (51.7%) | 4044 (61.6%) | 6565 |
| HIV | 1704 (8.3%) | 1386 (6.7%) | 1554 (7.6%) | 2581 (12.6%) | 7068 (34.4%) | 20564 |

The reduction of the amount of training data needed for training a model can lead to a significant reduction in computational complexity of model training and data storage at minimal to no loss of predictive performance, which can reduce training time as well as hardware requirements.

In addition to reduced data requirements for training models, it is possible to perform efficient active learning and constructive training set recombination. Since it is possible to reselect datapoints that have been eliminated, new labels may not be required to be acquired at every learning iteration, as is done in classical active machine learning. Instead, if a datapoint is added again, the previously acquired label can be used for inclusion into the training data and therefore additional data can be added at no additional cost for experiments to acquire a new label.

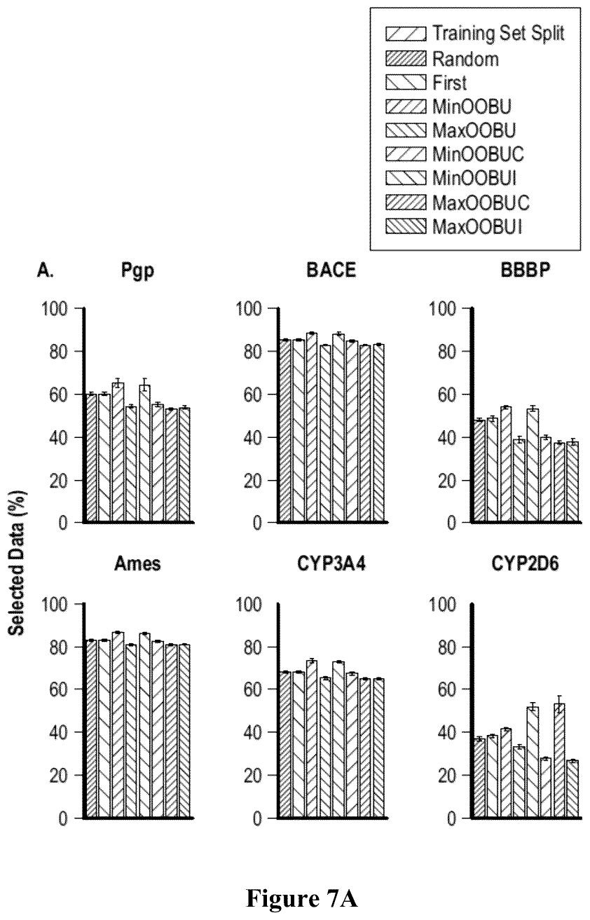

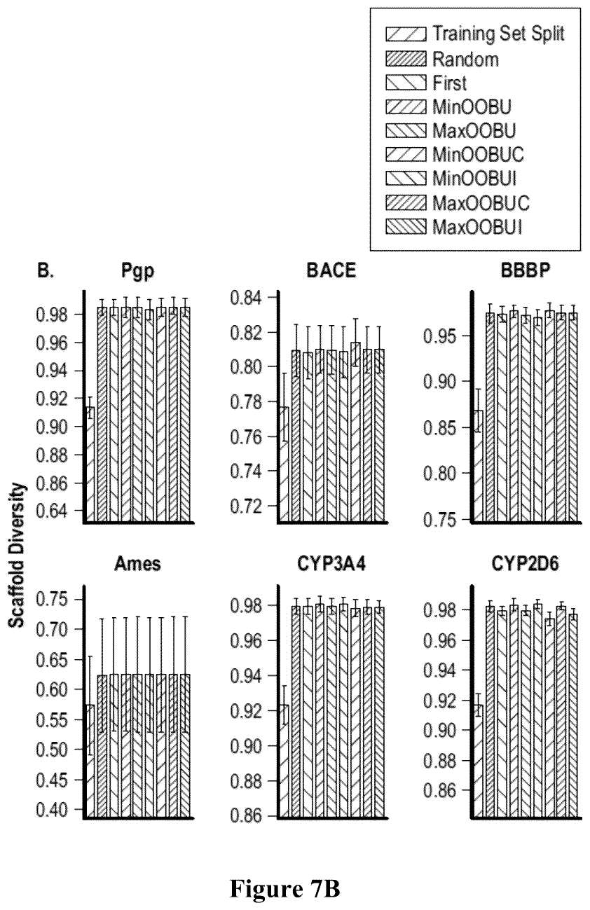

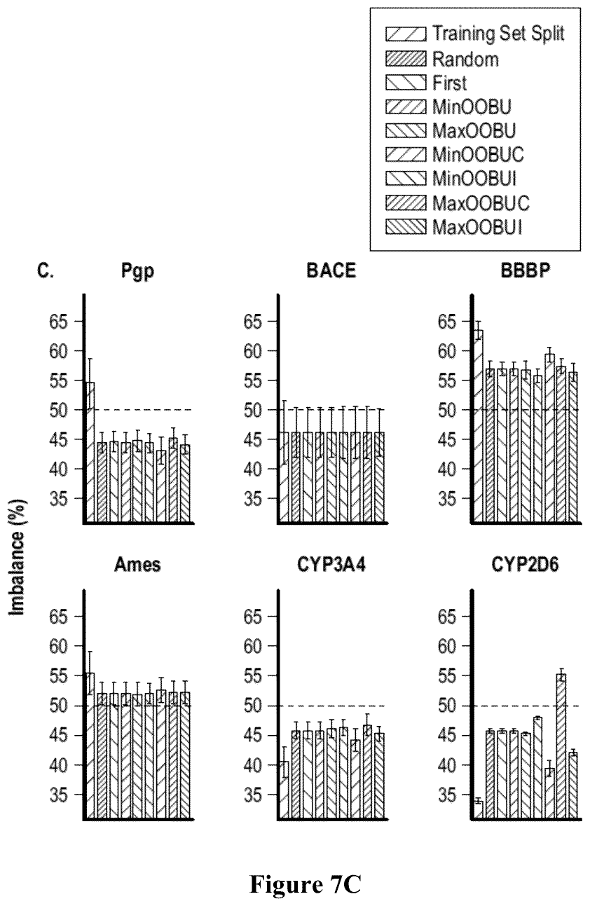

FIGS. 7A-7C illustrate data selection cost across datasets for different elimination protocols. FIG. 7A shows an amount of training data selected throughout the entire active learning process; FIG. 7B shows scaffold diversity of the final active learning iteration of the training set compared to the entire training pool seeded split; and FIG. 7C shows the imbalance of the final active learning iteration of the training set compared to the entire training pool seeded split.

Referring to FIG. 7A, it can be seen that across all datasets, the data selection cost mimicked the observed trend in training set size, indicating that examples requiring smaller training set sizes also require less new labeling demand. For datasets such as BBBP and CYP2D6, the labeling cost across most elimination protocols is reduced by at least 50%.

Referring to FIGS. 7B, across all datasets, it is possible to obtain training sets that have a vastly improved diversity profile. Since all tested elimination protocols achieve comparable scaffold diversity to random forgetting, this property is likely driven by the datapoint selection process rather than the forgetting protocol. Nonetheless, the improved scaffold diversity is a distinct benefit of the synergistic re-selection process. Referring to FIG. 7C, improvement to the imbalance within training sets across most datasets (e.g. BBBP, Ames, CYP3A4, CYP2D6) can be seen by the correction of the binary class distributions towards 50%. Notably, data rebalancing is a common strategy to improve predictive performance. However, Pgp observes an imbalance overcorrection, while BACE observes no correction at all. Similar to the scaffold diversity, there exists relatively uniform performance across elimination protocols.

Dataset perturbation was conducted by incorporating pre-specified ratios of corrupted labels were incorporated into the initial pool set prior to initializing the training set. These pre-specified ratios ranged from 0% to 40% error, in increments of 10%. Statistical testing was performed using the Wilcoxon signed-rank test. The Wilcoxon test is a non-parametric alternative to the paired Student's t-test. To quantify molecular diversity of the training sets, a simple scaffold diversity metric was defined as m/n, where m is the number of unique (Murcko) scaffolds in the final training set and n is the number of molecules in the final training set.

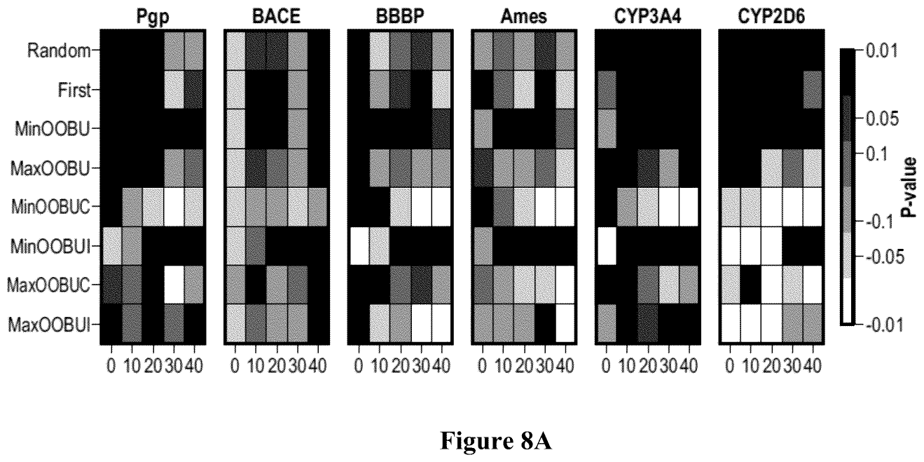

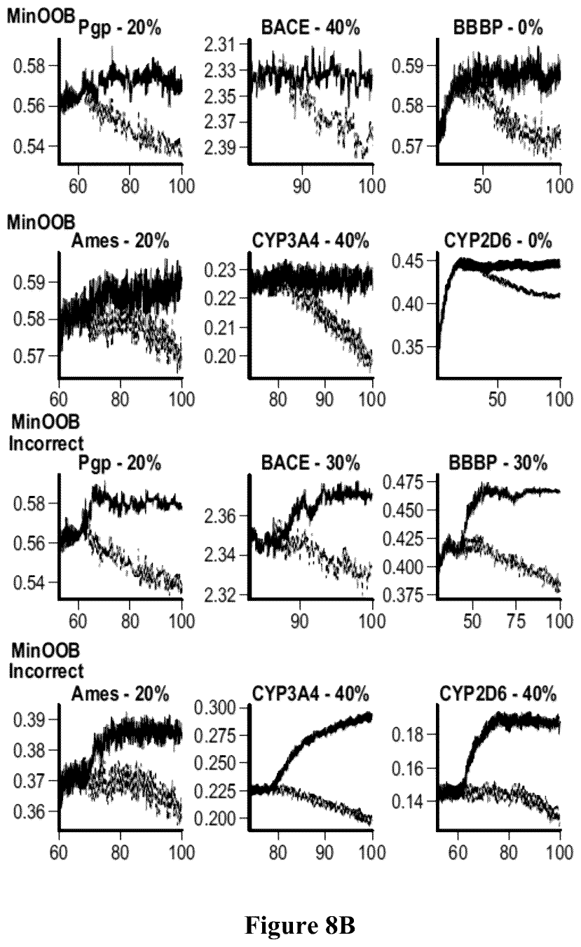

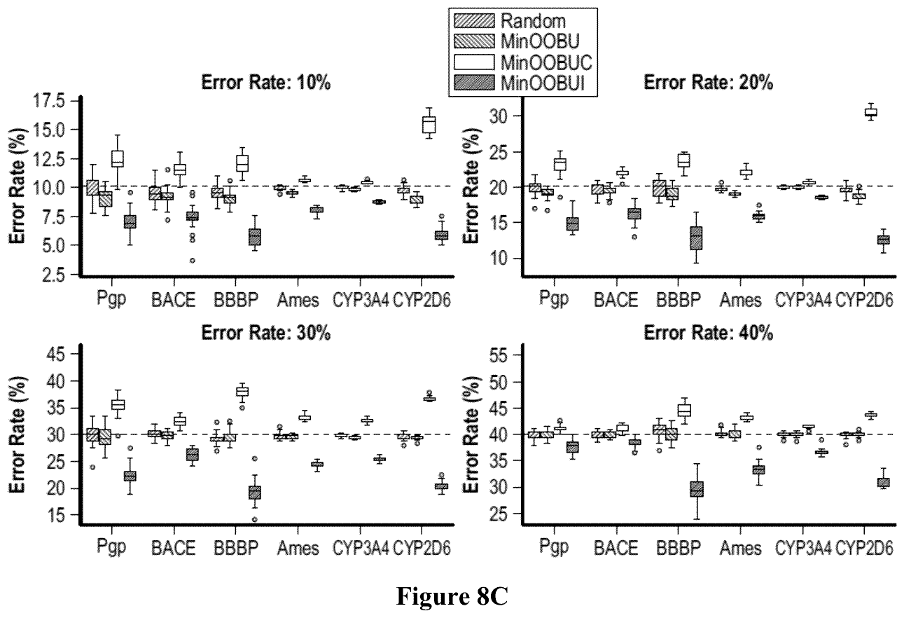

FIGS. 8A-8C show effects of dataset perturbation. FIG. 8A shows individual heatmaps for each dataset. Positive p-values quantify the significance associated with samples where mean AULC for an elimination capability is greater than mean AULC for standard active learning. Negative p-values quantify significance associated with samples where mean AULC for the elimination capability is worse than mean AULC for standard active learning. P-values are transformed in order to highlight magnitude of significance, as indicated by the color bar.

For example, with reference to the heatmaps for BACE, it can be seen that when there is no error, there is no improvement (e.g., the p-values are around 0). However, with 10-40% error, multiple forgetting protocols lead to significant improvements on the BACE dataset. Even more importantly, when introducing error to the data it is possible to distinguish the different elimination protocols more clearly. Most prominently, the strategy of removing the “least uncertain” (MinOOBU) examples from the training data led to improvements in almost all of the test cases across datasets, indicated by the band of significant positive results. Another interesting prominent result was the increase in performance for MinOOBU Incorrect as the error rates increased, where this protocol had initially produced either negligible or worse performance in comparison to standard active learning on 0% error.

FIG. 8B shows selected examples of a performance comparison with and without inclusion of an elimination protocol at various error rates. Based on the promising results observed in FIG. 8A, selected example curves are displayed in FIG. 8B. Curves were chosen based on a combination of the absolute increase in AULC and the significance (regardless of error rate). For all the example cases, MinOOBU is resistant to drops in performance as active learning progresses, and in some cases even offers slight increases in performance trajectory. Interestingly, for MinOOBU Incorrect it can be seen that there are cases where application of an elimination protocol substantially increases performance relative to standard active learning for error rates of 20-40%. MinOOBU Incorrect not only prevents a reduction in performance as corrupted data is introduced but appears to reverse the effect.

FIG. 8C shows an error rate for the final iteration of a training set in comparison to the amount of error that was originally introduced to the training pool across the different datasets. Based on the trends identified in FIG. 8B, experiments were conducted to quantify how the MinOOBU Incorrect elimination protocol can inhibit accumulation of erroneous data within the training set. As shown in FIG. 8C, it can be seen that MinOOBU Incorrect does lead to a reduction in error rate within the training set. To further validate that the erroneous data correction was a result of optimized elimination protocols, MinOOBU and MinOOBU Correct were also evaluated with respect to accumulation of erroneous data. While MinOOBU led to slight observable benefits on 10-20% error rates, MinOOBU Correct resulted in an increase in erroneous data accumulation across most test cases. These results could suggest that training datapoints that the model is certain about and predicts correctly (MinOOBU Correct) should not be excluded from the training set. This is further supported by the observation that this elimination protocol is only effective on error rates of 0-10% in some cases. Conversely, training datapoints that the model is certain about, but predicts incorrectly (MinOOBU Incorrect), are likely to be erroneous datapoints. The model is likely to be less uncertain about the datapoint if the rest of the training set is in agreement about its properties. However, since the datapoint label does not match that of the what the training set suggests, it is likely erroneous. This, of course, does not account for examples in which there are valid chemical properties to explain disagreement, such as activity cliffs.

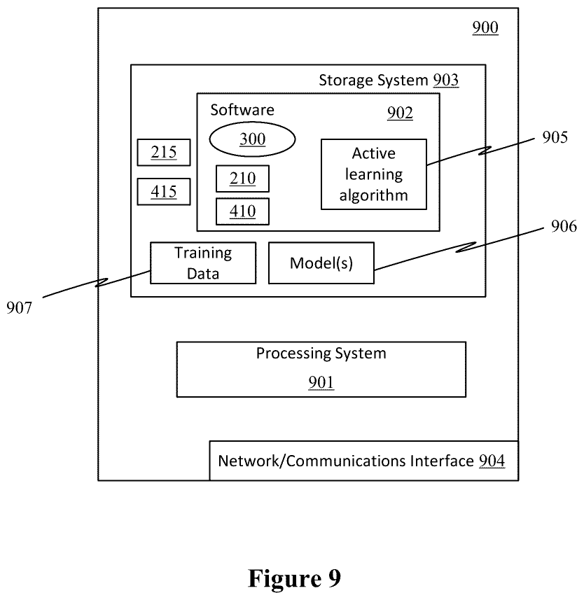

FIG. 9 illustrates components of a computing system that may be used in certain embodiments described herein. Referring to FIG. 9, system 900 may be implemented within a single computing device or distributed across multiple computing devices or sub-systems that cooperate in executing program instructions. In general, system 900 can include one or more blade server devices, standalone server devices, personal computers, routers, hubs, switches, bridges, mainframe computers, network-attached storage devices, and other types of computing devices.

The system 900 can include a processing system 901, which may include one or more processors and/or other circuitry that retrieves and executes software 902 from storage system 903. Processing system 901 may be implemented within a single processing device but may also be distributed across multiple processing devices or sub-systems that cooperate in executing program instructions.

Storage system(s) 903 can include any computer readable storage media readable by processing system 901 and capable of storing software 902. Storage system 903 may be implemented as a single storage device but may also be implemented across multiple storage devices or sub-systems co-located or distributed relative to each other. Storage system 903 may include additional elements, such as a controller, capable of communicating with processing system 901. Storage system 903 may also include storage devices and/or sub-systems on which data and executable instructions are stored. System 900 may access one or more storage resources in order to access information to carry out any of the processes indicated by software 902.

Software 902, including routines for performing various processes described herein, may be implemented in program instructions and among other functions may, when executed by system 900 in general or processing system 901 in particular, direct the system 900 or processing system 901 to operate as described herein. For example, software 902 can include, but is not limited to, instructions for elimination module 210, method 300, elimination module 410 (including supporting scenarios 400, 450, and 480 of FIGS. 4A-4C), and an active learning algorithm 905. As an illustrative example, instructions for an active learning method having elimination capabilities stored on the storage system 903, when executed by the processing system 901, can direct the computing system 900 to: select one or more datapoints from one or more resources; query an oracle for a label for each of the one or more datapoints that are unlabeled; add labeled datapoints to a labeled training dataset; train an active learning model using the labeled training dataset; monitor datapoints in the labeled training dataset as new labeled datapoints are added to the labeled training dataset; determine whether datapoints in the labeled training dataset satisfy a criterion for elimination operations of an elimination protocol; apply the elimination operations of the elimination protocol to remove one or more datapoints from the labeled training dataset; and update the machine learning model using an updated labeled training dataset as resulting from applying the elimination operations of the elimination protocol. Active learning iterations can continue by the instructions directing the computing system 900 to restart the active learning method as described until a stopping criterion is reached or the process is halted manually or through another external process.

Storage system 903 can include storage for storing model(s) 906 and training data 907 for active learning algorithm 905. Storage system 903 can also include an eliminated datapoint resource such as described with respect to eliminated datapoint resource 215 and eliminated datapoint resource 415.

In embodiments where the system 900 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 904 may be included, providing communication connections and devices that allow for communication between system 900 and other computing systems (not shown) over a communication network or collection of networks (not shown).

In some embodiments, system 900 may host one or more virtual machines.

Alternatively, or in addition, the functionality, methods, and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of datapoint elimination for an active learning algorithm, comprising:
monitoring datapoints in a labeled training dataset as new labeled datapoints are added to the labeled training dataset;
determining that datapoints in the labeled training dataset satisfy a criterion for elimination operations of an elimination protocol; and
applying the elimination operations of the elimination protocol to remove one or more datapoints from the labeled training dataset.

2. The method of claim 1, further comprising initiating an elimination protocol for eliminating a datapoint from a labeled training dataset.

3. The method of claim 2, wherein initiating the elimination protocol comprises identifying the elimination protocol from a set of available elimination protocols based on a type of dataset on which the active learning algorithm acts, a specific machine learning model for the active learning algorithm, or a combination thereof.

4. The method of claim 1, wherein monitoring the datapoints in the labeled training dataset as new labeled datapoints are added to the labeled training dataset comprises tracking an amount of datapoints in the labeled training dataset as the new labeled datapoints are added.

5. The method of claim 4, wherein the criterion for elimination operations is based at least in part on a number of datapoints in the labeled training dataset.

6. The method of claim 1, wherein monitoring the datapoints in the labeled training dataset as new labeled datapoints are added to the labeled training dataset comprises tracking predictive uncertainty of datapoints in the labeled training dataset as the new labeled datapoints are added.

7. The method of claim 1, wherein applying the elimination operations of the elimination protocol comprises:
selecting one or more labeled datapoints for removal from the labeled training dataset.

8. The method of claim 7, further comprising:
storing information of the selected one or more labeled datapoints removed from the labeled training dataset in an eliminated datapoint resource.

9. The method of claim 8, further comprising:
checking the eliminated datapoint resource for reference to a particular datapoint from the information of labeled datapoints removed from the labeled training dataset; and
providing information on the particular datapoint.

10. The method of claim 8, further comprising:
adding, by the active learning algorithm, new labeled datapoints to the labeled training dataset, wherein adding, by the active learning algorithm, new labeled datapoints to the labeled training dataset comprises:
selecting a particular datapoint from the eliminated datapoint resource for reintegration into the labeled training dataset.

11. The method of claim 1, wherein the elimination protocol is a forget random protocol, wherein applying the elimination operations of the elimination protocol comprises:
randomly selecting a training datapoint from the labeled training dataset to eliminate.

12. The method of claim 1, wherein the elimination protocol is a forget first protocol, wherein applying the elimination operations of the elimination protocol comprises:
selecting an oldest training datapoint from the labeled training dataset to eliminate.

13. The method of claim 1, wherein the elimination protocol is an uncertainty-based elimination protocol.

14. The method of claim 13, wherein the uncertainty-based elimination protocol is a forget Maximum Out-of-Bag Uncertainty (OOBU) or a forget Minimum OOBU, wherein applying the elimination operations of the elimination protocol comprises:
using quantified predictive out-of-bag uncertainty, selecting a most uncertain or a least uncertain training datapoint from the labeled training dataset to eliminate.

15. The method of claim 13, wherein the uncertainty-based elimination protocol is a forget Minimum Out-of-Bag Uncertainty (OOBU) Incorrect or a forget Minimum OOBU Correct, wherein applying the elimination operations of the elimination protocol comprises:
using quantified predictive out-of-bag uncertainty, selecting a least uncertain training datapoint from the labeled training dataset to eliminate while considering a class label of the training datapoint.

16. The method of claim 13, wherein the uncertainty-based elimination protocol is a forget Maximum Out-of-Bag Uncertainty (OOBU) Incorrect or a forget Maximum OOBU Correct, wherein applying the elimination operations of the elimination protocol comprises:
using quantified predictive out-of-bag uncertainty, selecting a most uncertain training datapoint from the labeled training dataset to eliminate while considering a class label of the training datapoint.

17. The method of claim 1, wherein the active learning algorithm performs drug-target interaction prediction, drug toxicity, or bioavailability, the datapoints in the labeled training dataset comprising molecules and associated activities.

18. The method of claim 1, further comprising:
updating a machine learning model by the active learning algorithm using the labeled training dataset as resulting from applying the elimination operations of the elimination protocol.

19. A computing system comprising:
a processing system;
a storage system;
instructions for an active learning method having elimination capabilities stored on the storage system that when executed by the processing system direct the computing system to:
select one or more datapoints from one or more resources;
query an oracle for a label for each of the one or more datapoints that are unlabeled;
add labeled datapoints to a labeled training dataset;
train a machine learning model using the labeled training dataset;
monitor datapoints in the labeled training dataset as new labeled datapoints are added to the labeled training dataset;
determine whether datapoints in the labeled training dataset satisfy a criterion for elimination operations of an elimination protocol;
apply the elimination operations of the elimination protocol to remove one or more datapoints from the labeled training dataset; and
update the machine learning model using an updated labeled training dataset as resulting from applying the elimination operations of the elimination protocol.

20. The computing system of claim 19, wherein instructions to select one or more datapoints from the one or more resources direct the computing system to select one or more datapoints from an unlabeled data pool and an eliminated datapoint resource storing information of the removed one or more datapoints from the labeled training dataset.
